(19) United States
(12) Patent Application Publication
(10) Pub. No.: US 2009/0235816 A1
(43) Pub. Date: Sep. 24, 2009

(54) PASSIVE APPARATUS AND METHOD FOR FILTERING NOXIOUS GASES

(76) Inventors: Anthony FARRUGIA, Donvale (AU); Ernest James Benson, East Ringwood (AU); David Ian Holm, Buffalo (AU)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/238,993

(22) Filed: Sep. 26, 2008

Related U.S. Application Data
(63) Continuation-in-part of application No. PCT/AU2007/000402, filed on Mar. 30, 2007.

(30) Foreign Application Priority Data
Mar. 31, 2006 (AU) 2006901719

(51) Int. Cl. B01D 53/14; B01D 46/46; B01D 53/34

(52) U.S. Cl. 95/23; 96/110; 422/177; 55/385.2

(57) ABSTRACT

A filtering apparatus (50) for removing noxious gases from an environment including: a source of compressed gas (60) connected to a regulating valve (62) to regulate a supply of compressed gas; at least one airflow device (5) including a compressed gas inlet (10) for receiving gas from the supply of compressed gas at greater than ambient atmospheric pressure, the gas inlet (10) being operably connected to the regulating valve (62); and a permeable noxious gas filter (55) arranged in gaseous communication with the airflow device (5); wherein the supply of compressed gas to the airflow device (5) causes the airflow device (5) to draw ambient air (64) from the environment through a primary intake (42), thereby generating a flow of air through the noxious gas filter (55) and causing the substantial removal of noxious gases from the flow of air.

### FIELD OF THE INVENTION

The present invention relates to a method and apparatus for filtering noxious gases from the environment and is particularly well suited for the removal of carbon dioxide and other noxious gases from ambient air in environments where there is no source of fresh air.

### BACKGROUND OF THE INVENTION

The removal of noxious gases such as carbon dioxide and/or other noxious gases is important for sustaining human life in environments where there is no available source of fresh air. Providing a life sustaining environment with respirable air is of particular concern in industries or situations where human beings could be subject to an environment where the available supply of respirable air is either depleted or ceases. This can occur in any instance where human beings are required to work underground or under water and are provided with a source of respirable air that is drawn from above ground or sea level. With respect to underground environments, one of the most common situations in which a potential exists for loss of human life as a result of inadequate respirable air is the mining industry. In this industry, it is usual for safety regulations to require a provision of some form of alternative respirable air for mine workers such that they may use an alternative source of respirable air in the event of a mine accident or fire that depletes usual sources of respirable air.

For the purpose of this specification, the particular requirements of the mining industry will be described to explain circumstances necessitating the filtering of noxious gases to sustain human life. However, it will be recognised by those skilled in the relevant field of technology that there are many other environments in which it is necessary to filter noxious gases and for which an apparatus and method according to the present invention is equally relevant.

In the mining industry, refuge stations, chambers and safety shelters are known for providing a safe environment for workers in emergency situations in the mine that could affect the health and/or safety of mine workers. Refuge chambers are generally a room that forms an enclosed environment substantially sealed from the mine environment and provides a location where a number of mine personnel may reside until such time as the hazardous condition external to the chamber has been removed or personnel can be rescued. Refuge chambers are generally equipped with apparatus to ensure that the chamber provides respirable air for the mine workers for a predetermined period of time. It is also not unusual for refuge chambers to include their own electrical power generating equipment in order to power air conditioning and other devices to improve the safety or comfort of mine workers whilst residing in a refuge chamber.

In providing an environment with respirable air, refuge chambers have used filters for the purpose of filtering noxious gases from the air contained within a refuge chamber. As time passes, the level of carbon dioxide in a refuge chamber will increase as oxygen is consumed by the occupants of the chamber and carbon dioxide is expelled. In order to remove the carbon dioxide, it is not unusual for a refuge chamber to include a permeable material that absorbs carbon dioxide from the atmosphere with an electrically powered fan arranged to either draw or force air through the carbon dioxide filtering medium.

However, there are some environments where it is not possible to use an electrically powered fan or blowing device for the purpose of passing air through a permeable filtering medium. For example, in the coal industry, the use of a spark generating device is considered hazardous as it significantly increases the risk of ignition of hydrocarbons in the atmosphere leading to a fire or explosion.

As a result, in the coal mining industry, miners are usually provided with a portable breathing apparatus that is worn by them at all times. In the event of a fire or other hazardous condition, the coal miner is required to activate the portable breathing apparatus and attempt to escape the hazardous condition. This approach is usually referred to as a “self escape” philosophy which has been practiced in the coal mining industry for many years.

The “self escape” philosophy suffers numerous disadvantages but the limitation of how much a coal miner can carry whilst still performing his or her duties is a primary factor. As a result, any breathing apparatus carried by a coal miner will only provide respirable air to the miner for a limited time. This time limitation will in turn directly relate to the period of time for which the life of the coal miner may be preserved when ambient respirable air is unavailable in the mine environment. Accordingly, deaths of coal miners continue to occur when the limited period of time a portable breathing apparatus can operate is not sufficient to enable the miner to remain alive until they can escape or are rescued.

Therefore, there is a need for an alternative approach to protecting human life in environments that are highly flammable and that are subject to a high risk of fire and/or explosion, such environments thus disallowing the use of spark generating equipment such as electric motors.

Any discussion of documents, devices, acts or knowledge in this specification is included to explain the context of the invention. It should not be taken as an admission that any of the material formed part of the prior art base or the common general knowledge in the relevant field of technology on or before the priority date of the claims herein.

### SUMMARY OF THE INVENTION

According to the present invention, there is provided a filtering apparatus for removing noxious gases from an environment including:
a source of compressed gas connected to a regulating valve to regulate a supply of compressed gas;
at least one airflow device including a compressed gas inlet for receiving gas from the supply of compressed gas at greater than ambient atmospheric pressure, the gas inlet being operably connected to the regulating valve; and
a permeable noxious gas filter arranged in gaseous communication with the airflow device;
wherein the supply of compressed gas to the airflow device causes the airflow device to draw ambient air from the environment through a primary intake, thereby generating a flow of air through the noxious gas filter and causing the substantial removal of noxious gases from the flow of air.

In a preferred embodiment, the airflow device is an airflow amplifier that operates on the venturi principle, whereby the compressed gas can enter a substantially annular chamber which is in gaseous communication with the gas inlet. In this embodiment, the compressed gas received by the gas inlet subsequently passes through the annular chamber before being expelled through an outlet of the airflow device, preferably along with the ambient air drawn into the airflow device from the primary intake. The annular chamber is also preferably internal to airflow amplifier and, the compressed gas flow can adhere to a coanda profile which directs the gas to the outlet of the airflow amplifier. At the same time, a low pressure area is created in the central region of the outlet of the airflow amplifier which causes ambient air to be drawn in through the primary intake and into the airflow amplifier.

The filtering apparatus can include more than one airflow device, and the one or more airflow devices can be arranged in either upstream or downstream gaseous communication with respect to the permeable noxious gas filter. However, in a preferred embodiment of the invention, at least one airflow device is arranged downstream of the noxious gas filter such that air is drawn through the filter by the action of the airflow device before it is drawn into the airflow device and subsequently expelled therefrom into the environment.

In another preferred embodiment, the airflow device includes an air driven turbine rotor which drives a fan, similar to an arrangement for compressed air driven dental drills known to the Applicant, whereby an air driven turbine rotor is used to instead drive a dental drill bit. This arrangement can be used as a single airflow device, or can alternatively be used in combination with another airflow device which could be an airflow amplifier.

In an embodiment where the airflow device is arranged in gaseous communication downstream of the noxious gas filter, a deflector can be arranged between the airflow device and the noxious gas filter to deflect air flowing through the noxious gas filter through the airflow device.

In an alternative embodiment where the airflow device is arranged in gaseous communication upstream from the noxious gas filter, a deflector can be arranged between the airflow device and the noxious gas filter to deflect the air being drawn through the airflow device through the noxious gas filter.

In embodiments having a deflector, the deflector can also form part of a cowl which extends at least part way between the airflow device and the noxious gas filter.

The noxious gas filter may be any filter arrangement that is effective in removing noxious gases from the ambient environment. In a particularly preferred arrangement, the noxious gas filter is in the form of a bed of particulate material that is effective in removing noxious gases as air flows through the bed of material. For example, soda lime can be used to effect removal of carbon dioxide from air and/or a metallic catalyst such as, but not limited to, SOFNOCAT™ can be used to remove carbon monoxide.

Indeed, one bed may be provided containing soda lime for removal of carbon dioxide and a separate bed may be provided containing metallic catalyst for removal of carbon monoxide, with the air flow passing through both beds. The order in which the airflow passes through the beds may be selected as desired.

In an embodiment of the invention that uses air as the compressed gas, the supply of air to the environment further improves the quality of the respirable air in the environment along with the substantial removal of noxious gases from the ambient air before it is drawn through the airflow device. In a preferred embodiment, the source of compressed gas includes one or more bottles of compressed air.

The filtering apparatus can also include a control system for controlling the regulating valve to regulate the supply of compressed gas to the airflow device, and hence can affect the flow rate of air passing through the noxious gas filter. Alternatively, the regulating valve can be manually operated. Of course, the flow rate of air discharged from the airflow device is greater than the flow rate of air drawn into the airflow device as the discharge from the airflow device includes both the air drawn into the airflow device and the gas supplied to the airflow device by the regulating valve.

Different airflow devices will have different characteristics with respect to the resulting airflow through the device when provided with compressed gas at the compressed gas inlet. The resulting airflow rate through the airflow device and the physical characteristics of the noxious gas filter affect the amount of time that air is subjected to the noxious gas filter. In a preferred embodiment, the regulating valve regulates the supply of compressed gas to flow at or above a minimum operational flow rate, enabling the noxious gas filter sufficient time to substantially remove noxious gases from the flow of air passing therethrough.

The control system can further include a noxious gas sensor for measuring the amount of noxious gas in the environment. In this embodiment, the noxious gas sensor is operably connected to a control device for controlling the regulating valve to maintain the amount of noxious gas (for example, carbon dioxide levels) at an acceptably low level. The noxious gas sensor could, for example, include an infrared device for the purpose of detecting the presence of carbon dioxide.

In highly combustible environments, such as experienced in the coal industry, the use of spark generating devices is considered hazardous as it significantly increases the risk of ignition of hydrocarbons in the atmosphere leading to a fire or explosion. To enable use of electrical components in such highly combustible environments, embodiments including a control system preferably include electrically operated components which are non-spark generating electrical components such as semi conducting devices, non spark generating transducers and/or electromechanical actuating devices.

In an embodiment of the invention including a control system, the minimum airflow rate of the airflow device should preferably be considered when controlling the supply of compressed gas to the airflow device. In particular, to maintain noxious gas levels to an acceptable level with an airflow device that has a relatively high minimum flow rate, the compressed gas is preferably supplied intermittently, or in bursts. The duty cycle of the supply of compressed gas will vary according to the measure of noxious gas in the environment.

According to the present invention, there is also provided a refuge chamber including the filtering apparatus as described in any one of the embodiments above, wherein the environment from which the noxious gases are removed is defined within the refuge chamber.

It is preferable that the environment within the mine refuge chamber can be sealed with a seal, such that the chamber has a self contained atmosphere and is sealed against ingress of external atmosphere prior to or shortly after activation of the filtering apparatus.

The refuge chamber may also include one or more bottles of compressed gas forming the supply of compressed gas through a regulating valve to the airflow device. In this respect, a regulating valve may be attached to a bottle of compressed gas by manually attaching a hose and clamp arrangement to the bottle of compressed gas. Upon depletion of the compressed gas from that particular bottle, the hose and clamping arrangement may then be manually removed from the depleted bottle and a fresh bottle of compressed gas may be used to replace the depleted bottle of gas. Alternatively, the regulating valve may be connected to a header arrangement that includes numerous hoses and clamping arrangements attached to a number of bottles of compressed gas thus enabling control of the supply of compressed gas from a number of bottles to the airflow device without manually disconnecting and reconnecting hose or clamp arrangements.

In any particular arrangement, the refuge chamber can include a sufficient number of bottles of compressed gas to sustain human habitation with respirable air for a period of time deemed sufficient to remove or ameliorate any hazardous condition that may occur.

It is an advantage for mine refuge chambers to optionally operate without connection to external supplies, such as supplies of electrical power or external sources of fresh air etc. Whilst it is possible to specify a minimum supply of compressed gas to support an environment with respirable air for a period of time, clearly it is preferable that the environment within a refuge chamber be maintained with respirable air for as long as possible thus enabling rescue workers a maximum period of time in which to remove or ameliorate a hazardous condition.

Accordingly, in a particularly preferred embodiment, the mine refuge chamber includes a regulating valve controlled by a control system that measures the presence of noxious gases such as carbon dioxide in the environment contained within the refuge chamber. The control system can adjust the regulating valve in order to maintain oxygen and carbon dioxide levels within acceptable limits for providing respirable air. Such a control system is preferably powered by electrical charge stored in batteries and, with this particular arrangement, it is possible to extend the period over which the respirable air quality remains for as long as possible. For example, if the refuge chamber is not fully occupied to maximum capacity, the control system may detect a lower consumption of oxygen and generation of carbon dioxide, and may adjust the regulating valve such that only an amount of air in the ambient environment within the mine refuge chamber is passed through the noxious gas filter as is required to remove carbon dioxide or other noxious gas that affects the quality of respirable air.

According to the present invention, there is also provided a filtering method for the removal of noxious gases from an environment, the method including the steps of:
regulating a supply of compressed gas to a compressed gas inlet of an airflow device; and
arranging a permeable noxious gas filter in gaseous communication with the airflow device; wherein
   when the compressed gas is supplied to the airflow device, the airflow device causes ambient air from the environment to be drawn through a primary intake, thereby generating a flow of air through the noxious gas filter which substantially removes noxious gases from the flow of air.

Further benefits and advantages of a filtering apparatus, a refuge chamber using the filtering apparatus, and a method according to the present invention will become apparent in the following description of a preferred embodiment of the invention.

### BRIEF DESCRIPTION OF THE DRAWINGS

Preferred embodiments of the invention will now be described. The preferred embodiments should not be considered as limiting any of the statements in the previous section. The preferred embodiments will be described with reference to the following figures in which:

FIG. 1a is a sectioned side view of an airflow device detailing a compressed gas inlet and the resulting airflow through the device;

FIG. 1b is a cross-sectional view of the airflow device of FIG. 1a, along the line 1b;

FIG. 2a is a partially sectioned side view of an filtering apparatus according to one embodiment of the present invention, detailing flow of ambient air from the environment through a noxious gas filter, the flow of air being substantially deflected before flowing through an airflow device, and then being expelled as filtered air back into the environment;

FIG. 2b is a partially sectioned side view of an filtering apparatus according to another embodiment of the present invention, detailing flow of ambient air from the environment through a noxious gas filter, the flow of air being partially deflected before flowing through an airflow device, and then being expelled as filtered air back into the environment; and

FIG. 3 is a simplified diagram of an airflow device of one particular embodiment with associated characteristics detailed in tabular form.

### DETAILED DESCRIPTION OF PREFERRED EMBODIMENTS

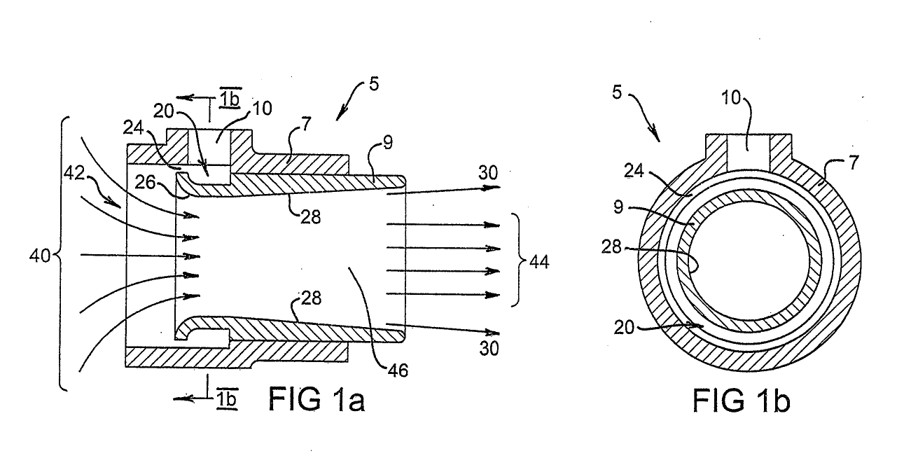

The preferred embodiments of the invention include an airflow device known as an “air amplifier” as it results in a flow rate of air through the device substantially greater than the flow rate of the compressed gas supplied to the airflow device. However, it will be recognised by those skilled in the relevant field of technology that any airflow device activated by a supply of compressed gas may be used. With reference to FIG. 1, a sectional side view of an air amplifier (5) is detailed. The air amplifier (5) includes a main body (7) with a profiled internal airflow guide (9) firmly attached to the interior of the main body (7). The air amplifier (5) is substantially circular with the main body (7) extending the entire circumference thus forming an outer casing of the air amplifier (5) with the internal airflow guide (9) also extending the entire circumference internally of the air amplifier (5).

The main body (7) includes an aperture forming a compressed gas inlet (10). Whilst the compressed gas inlet (10) does not extend the full circumference of the main body (7), the compressed gas inlet (10) provides an inlet for compressed gas into the internal core of the air amplifier (5) although upon entry into the air amplifier (5) the compressed gas is initially substantially contained within an internal annular chamber (20) that is formed between surfaces of the main body (7) and the internal airflow guide (9).

The internal annular chamber (20) extends the entire circumference internal to the air amplifier (5) although a relatively small gap (24) allows compressed gas to pass from the annular chamber (20) to the main internal cavity of the airflow amplifier (5). However, when compressed gas (coanda effect) passes from the annular chamber (20) through the gap (24) it substantially adheres to the curved surface (26) of the internal airflow guide (9) and subsequently to the relatively flat surface (28) (in profile) as the gas from the compressed air source exits from the air amplifier (5) in the direction of the arrows (30). In adhering to the curved surface (26) (in profile) and the relatively flat surface (28) (in profile), the gas effectively follows a coanda profile of the surface of the internal airflow guide (9).

As the gas exits the air amplifier (5) along the direction of the arrows (30), a region of low air pressure is generated in an inner region of the air amplifier (5) substantially located in the central region about a nominal axis of symmetry extending through the centre of the air amplifier (5), the axis of symmetry being substantially aligned with the airflow through the air amplifier (5). The region of low pressure causes air external to the air amplifier (5) to be drawn into the air amplifier (5) substantially following paths indicated by the arrows (40). The external air is then propelled through the air amplifier (5) and expelled from the outlet substantially following the direction of the arrows (44). The air drawn into the air amplifier (5) is drawn through a primary intake (42) and expelled from the air amplifier (5) through an outlet (46).

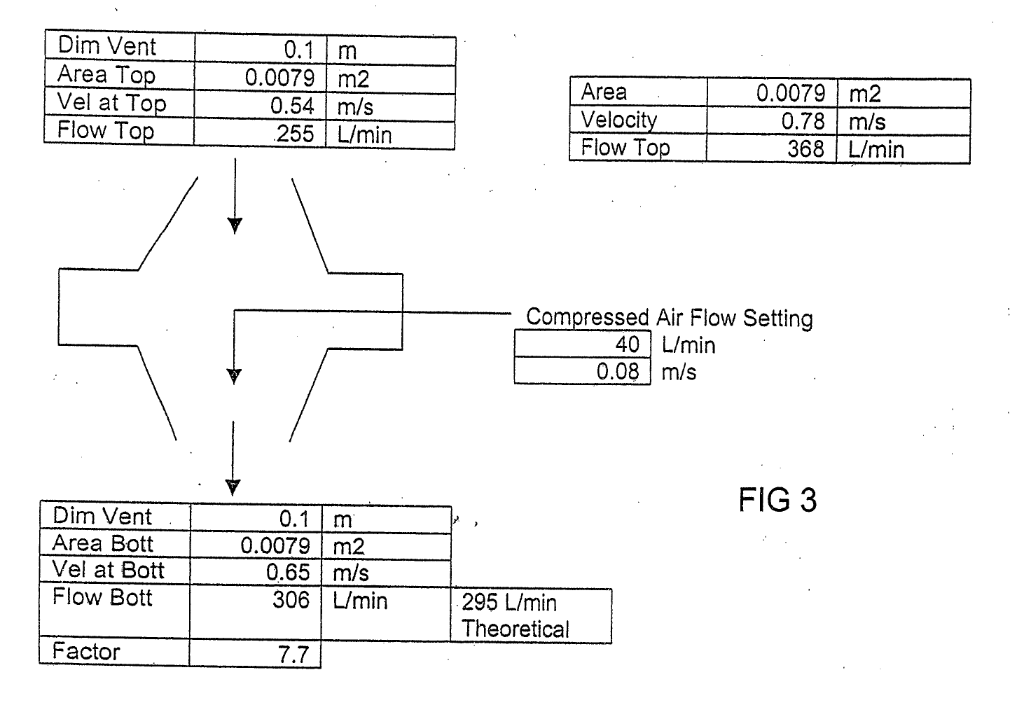

Irrespective of the particular design of the airflow device, it is important that the device is operable to generate an airflow upon activation by the supply of compressed gas to the device. In this respect, various airflow devices may have minimum flow rates which would need to be accommodated when considering the overall configuration of an apparatus for filtering noxious gases. Further details of an airflow device according to an embodiment of the invention are provided in FIG. 3.

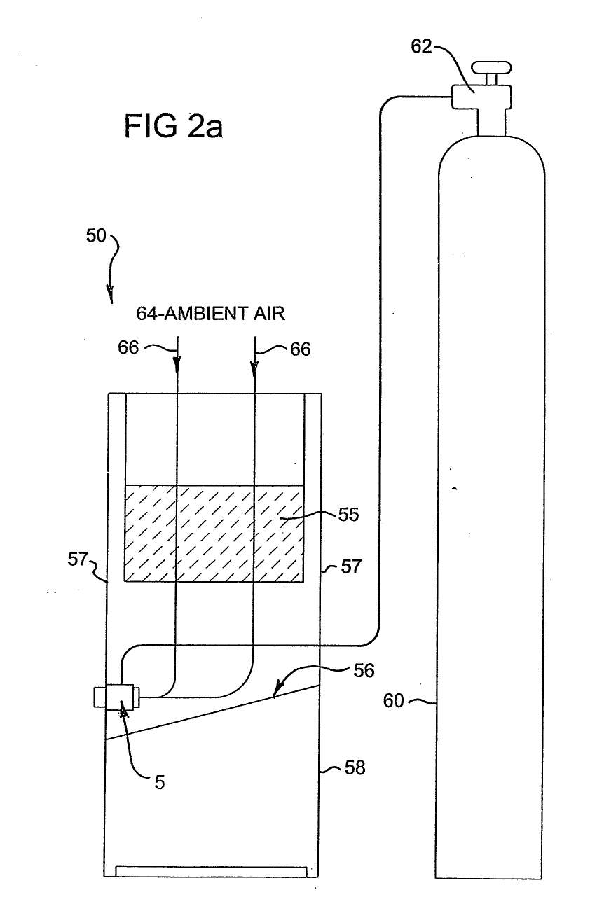

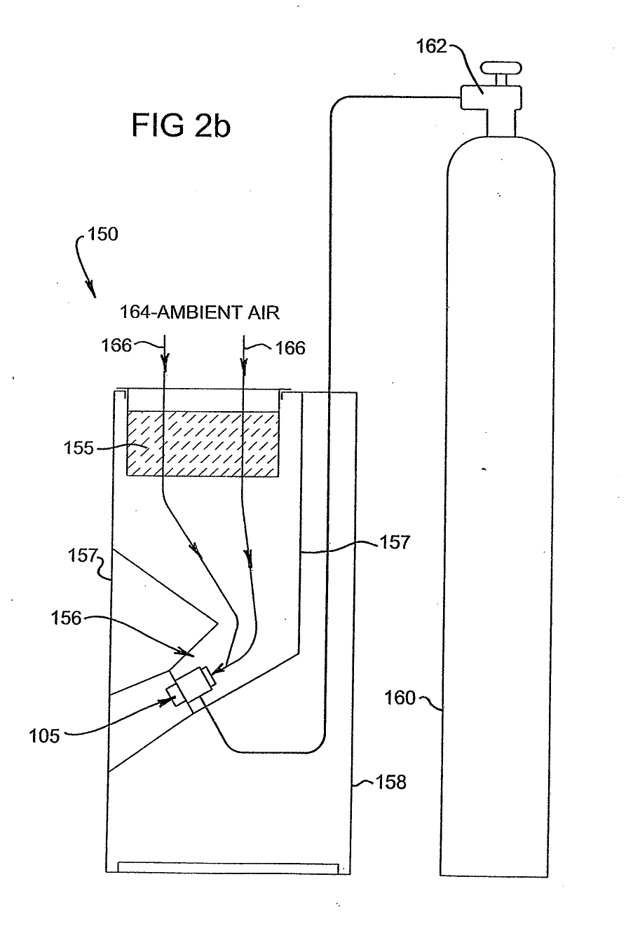

FIGS. 2a and 2b show alternative embodiments of a filtering apparatus according to the invention. Where the primary components of the filtering apparatus illustrated in FIG. 2b are similar to the components of the filtering apparatus illustrated in FIG. 2a, similar components are given the same reference numeral, differing by 100.

With reference to the embodiments illustrated in FIGS. 2a and 2b, the primary components of a complete air filtering apparatus are shown including an air amplifier (5) operably connected to a store of compressed gas (60) and mounted in a cabinet (58). The cabinet (58) also includes a bed of particulate material (55), such as soda lime, which substantially removes a noxious gas, such as carbon dioxide, from any air flowing through the bed of that particulate material. The cabinet (58) houses the bed of particulate material (55) and locates same upstream of the air amplifier (5) and provides a cowl or shroud arrangement (generally indicated at (57/157)) that substantially seals the primary intake of the air amplifier (5) from the external environment thus causing any air drawn by the air amplifier (5) to be drawn through the bed of particulate material (55).

The bed of particulate matter may include a metallic catalyst, such as SOFNOCAT™ (or equivalent) for removing carbon monoxide. Indeed, although not illustrated, the metallic catalyst may be provided in a separate bed to that of particulate material (55); with the separate bed provided either upstream or downstream of the bed illustrated. The additional bed may be provided in a separate filtering apparatus to apparatus (50), either upstream or downstream of apparatus (50).

Operation of the regulating valve (62) causing the supply of compressed gas to the gas inlet of the air amplifier (5) causes the air amplifier (5) to draw ambient air through its primary intake. Due to a deflector (56/156) (see FIG. 2a/2b) which can form part of the cowl or shrouding arrangement (57/157) of the cabinet (58), ambient air (64) is drawn through the bed of particulate material (55) along the direction of the arrows (66) and subsequently into the primary intake of the air amplifier (5). The deflector (56/156) can be arranged at any suitable angle to deflect the air flow between the air amplifier (5) and the bed of particulate material (55), such that the contact or dwell time of the air passing through the bed of particulate material (55) is optimised. Of course, passage of the ambient air (64) through the bed of particulate material (55) desirably removes the noxious gas from the ambient air prior to that air being drawn into the air amplifier (5) and ultimately expelled therefrom back into the environment.

In an embodiment of the invention the filtering apparatus (50) includes a bottle of compressed gas (60) containing compressed air that is released by operating the regulating valve (62). The compressed air from the bottle (60) is connected to the compressed gas inlet of the air amplifier (5). Further, in this embodiment, the bed of particulate material (55) includes soda lime for substantially removing carbon dioxide from the ambient air (64) and during operation of the filtering apparatus (50), the air expelled from the air amplifier (5) includes ambient air filtered through the bed of soda lime (55) along with decompressed air supplied from the bottle (60). In this particular instance, the air expelled from the air amplifier (5) comprises air that is relatively rich in oxygen and has relatively low levels of carbon dioxide as compared with the ambient air in the environment thus improving the respirable quality of the air in the environment for human occupants.

In another embodiment (not illustrated), a sensor (not shown) detecting the presence of carbon dioxide is connected to a control system that automatically controls the regulating valve (62) thus ensuring that only a necessary amount of compressed gas (air) is supplied to the air amplifier (5) to maintain carbon dioxide levels to an acceptable limit. This is particularly useful during circumstances where a refuge chamber may not be fully occupied and as a result, substantially less compressed gas (air) may be used per unit time to maintain carbon dioxide levels at an acceptable limit, thus increasing the period of time for which respirable air will be available to the occupants of the refuge chamber.

With reference to FIG. 3, a simplified diagram of an air amplifier according to one embodiment of the invention is shown with characteristics of airflow rates and velocity are detailed in tabular form. Compressed air is supplied to the compressed gas inlet of the air amplifier at a rate between 20 to 60 litres per minute. This flow rate is provided to one or more air amplifiers and the airflow rate at the outlet of the air amplifier is between 6 to 12 times the airflow provided at the compressed gas inlet. Accordingly, the air amplifier exhausts air at the outlet between 120 litres and 720 litres per minute.

Of course, the choice of particular airflow rates will depend to a large extent upon the size of the environment for which respirable quality air is required and the number of occupants in that environment. In a particular embodiment of the invention that is used to extract carbon dioxide from the ambient air, air is drawn through a bed of particulate material being either soda lime or lithium hydroxide. In order to effectively remove carbon dioxide from air drawn through the particulate material, the dwell time required (i.e. the period of time for which air is required to be in contact with the particulate material) is half a second at a minimum. Further, in this particular embodiment, oxygen is introduced into the airflow at a rate of approximately half a litre per person per minute.

FIG. 3 details the particular characteristics of one embodiment of the invention although the characteristics detailed in FIG. 3 may not be applicable to all circumstances in which a noxious gas filter is required.

As the present invention may be embodied in several forms without departing from the essential characteristics, it should be understood that the above described embodiment should not be considered to limit the present invention but rather should be construed broadly within the spirit and scope of the invention. Various modifications and equivalent arrangements are intended to be included within the spirit and scope of the invention.

1. A filtering apparatus for removing noxious gases from an environment comprising:
a source of compressed gas connected to a regulating valve to regulate a supply of compressed gas;
at least one airflow device including a compressed gas inlet for receiving gas from the supply of compressed gas at greater than ambient atmospheric pressure, the gas inlet being operably connected to the regulating valve; and
a permeable noxious gas filter arranged in gaseous communication with the airflow device;
wherein the supply of compressed gas to the airflow device causes the airflow device to draw ambient air from the environment through a primary intake, thereby generating a flow of air through the noxious gas filter and causing the substantial removal of noxious gases from the flow of air.

2. A filtering apparatus according to claim 1, wherein the airflow device is an airflow amplifier.

3. A filtering apparatus according to claim 2, wherein the airflow amplifier comprises a substantially annular chamber in gaseous communication with the gas inlet, wherein the compressed gas received by the gas inlet subsequently passes through the annular chamber before being expelled from the airflow amplifier.

4. A filtering apparatus according to claim 1, wherein the airflow device is arranged in gaseous communication downstream of the noxious gas filter, such that the air which is drawn through the primary intake flows through the noxious gas filter before being drawn into the airflow device and then subsequently being expelled from the airflow device into the environment.

5. A filtering apparatus according to claim 4, further comprising a deflector which is arranged between the airflow device and the noxious gas filter to deflect the air flowing through the noxious gas filter through the airflow device.

6. A filtering apparatus according to claim 1, wherein the airflow device is arranged in gaseous communication upstream from the noxious gas filter, such that the air which is drawn through the primary intake is drawn through the airflow device before flowing through the noxious gas filter, whereby the air flowing through the noxious gas filter is subsequently expelled into the environment.

7. A filtering apparatus according to claim 6, further comprising a deflector which is arranged between the airflow device and the noxious gas filter to deflect the air being drawn through the airflow device through the noxious gas filter.

8. A filtering device according to claim 5, wherein the deflector forms part of a cowl which extends at least part way between the airflow device and the noxious gas filter.

9. A filtering apparatus according to claim 1, wherein the source of compressed gas comprises at least one compressed gas bottle.

10. A filtering apparatus according to claim 1, wherein the compressed gas is compressed air.

11. A filtering apparatus according to claim 1, wherein the noxious gas filter comprises at least one bed of particulate material.

12. A filtering apparatus according to claim 11, wherein the particulate material comprises at least one of soda lime and a metallic catalyst.

13. A filtering apparatus according to claim 1, wherein the regulating valve is manually operated.

14. A filtering apparatus according to claim 1, further comprising a control system for controlling the regulating valve.

15. A filtering apparatus according to the claim 13, wherein, in operation, the regulating valve regulates the supply of compressed gas to flow at or above a minimum operational flow rate, enabling the noxious gas filter sufficient time to substantially remove noxious gases from the flow of air passing therethrough.

16. A filtering apparatus according to claim 15, wherein the control system comprises a noxious gas sensor for, in operation, measuring the amount of noxious gas in the environment, and wherein the noxious gas sensor is operably connected to a control device for controlling the regulating valve to maintain the amount of noxious gas in the environment at a desired level.

17. A filtering apparatus according to claim 16, wherein the noxious gas sensor comprises an infrared sensor.

18. A filtering apparatus according to claim 14, wherein the control system comprises electrically operated components which are non-spark generating electrical components, selected from a group comprising one or more of: semi-conducing devices, non-spark generating transducers and electromechanical actuating devices.

19. A filtering apparatus according to claim 1, comprising a mechanism for supplying the compressed gas intermittently.

20. A refuge chamber including the filtering apparatus according to claim 1, wherein the environment from which the noxious gases are removed is defined within the refuge chamber.

21. A filtering method for the removal of noxious gases from an environment, the method comprising the steps of:
regulating a supply of compressed gas to a compressed gas inlet of an airflow device; and
arranging a permeable noxious gas filter in gaseous communication with the airflow device; wherein
when the compressed gas is supplied to the airflow device, the airflow device causes ambient air from the environment to be drawn through a primary intake, thereby generating a flow of air through the noxious gas filter which substantially removes noxious gases from the flow of air.
